(19) United States
(12) Patent Application Publication
(10) Pub. No.: US 2026/0209546 A1
(43) Pub. Date: Jul. 23, 2026

(54) ACRYLIC EPOXY HYBRID-BASED COATING FOR IMPROVED HARDNESS

(71) Applicant: Rohm and Haas Company, Collegeville, PA (US)

(72) Inventors: Denise Lindenmuth, Ambler, PA (US); Zhenwen Fu, Norristown, PA (US); Andrew Heji, Lansdale, PA (US)

(21) Appl. No.: 19/139,335

(22) PCT Filed: Dec. 11, 2023
(86) PCT No.: PCT/US2023/083277

§ 371 Date: Jun. 14, 2025

Related U.S. Application Data
(60) Provisional application No. 63/433,924, filed on Dec. 20, 2022.

(51) Int. Cl. C09D 163/00; C09D 5/02; C09D 7/63

(52) U.S. Cl. CPC C09D 163/00; C09D 5/027; C09D 7/63

(57) ABSTRACT

The present invention relates to a two-component waterborne coating composition comprising a binder component and a curing component. The two-component waterborne coating composition comprises a coalescent package comprising at least one coalescent and has a minimum film formation temperature from 0° C. to 25° C. A method of preparing a coating and coated article are also disclosed.

### BACKGROUND OF THE INVENTION

In the coatings industry, especially the industrial coatings industry, coatings having both corrosion and hardness are often desired. Multiple layer coatings were developed to provide a first layer providing adhesion and corrosion resistance to the substrate. Additional layers were then applied to provide weather resistance, chemical resistance, and/or the desired appearance. Epoxy resins were generally selected for the first layer, while polyurethane resins or acrylic resins were often used for the upper layer(s). Different resin chemistries were used due to the difficulty of finding a single resin chemistry that provided the necessary balance between corrosion resistance and weather resistance.

Acrylic epoxy hybrid (AEH) resins, such as that disclosed in U.S. Pat. No. 8,658,742, were developed to provide a better balance between corrosion resistance and weather resistance in a single-chemistry system. These AEH resin systems allowed for one-coating systems that provided good corrosion resistance and weather resistance for many applications, such as in direct to metal coatings.

However, for some applications, the hardness and/or weatherability provided by existing AEH resin systems is not adequate.

There is a desire for a low cost and simple resin system, that can provide improved hardness. It is further desirable to provide a coating with improved hardness that is compatible with existing coatings.

### SUMMARY OF THE INVENTION

In a first aspect, the present invention relates to a two-component waterborne coating composition comprising a binder component and a curing component, wherein the binder component comprises an aqueous dispersion of acrylic polymer particles imbibed with an epoxy compound, wherein the coating composition comprises a coalescent package comprising at least one coalescent and has a minimum film formation temperature (MFFT) from 0° C. to 25° C.

In a second aspect, the present invention relates to a method of preparing a coating comprising:
(i) providing a coating composition of any one of the preceding claims;
(ii) applying the coating composition to a substrate to form a coating layer;
(iii) curing the coating layer to form a coating on the substrate at a temperature greater than room temperature for at least 10 minutes.

A third aspect of the present invention relates to an article comprising a coated substrate formed by the above method.

### DETAILED DESCRIPTION OF THE INVENTION

In a first aspect, the present invention relates to a coating composition comprising a two-component waterborne coating composition having improved hardness.

The two-component waterborne coating composition comprises a binder component and a curing (i.e., crosslinking) component. The binder component comprises an aqueous dispersion of acrylic polymer particles imbibed with an epoxy compound. As used herein, the term “acrylic” includes (meth)acrylic acid, (meth)alkyl acrylate, (meth)acrylamide, (meth)acrylonitrile and their modified forms such as (meth)hydroxyalkyl acrylate. The fragment “(meth)acryl” refers to both “methacryl” and “acryl,” such as, for example, (meth)acrylic acid referring to both methacrylic acid and acrylic acid and methyl (meth)acrylate referring to both methyl methacrylate and methyl acrylate. As used herein, the term “imbibed with an epoxy compound” means that the epoxy compound is absorbed at least in part by the acrylic polymer particles, but not reacted with the acrylic polymer particles, and is not merely present on the surface of the acrylic polymer particles.

Preferably, the aqueous dispersions of acrylic polymer particles imbibed with an epoxy compound comprise stable aqueous dispersions of acrylic polymer particles imbibed with a thermosettable compound having at least two oxirane groups. As used herein, the term “thermosettable compound” means a compound that will undergo a chemical reaction to form a thermoset compound which has different chemical and physical properties and does not undergo a reversible thermal transition when exposed to heat.

The imbibed thermosettable compound preferably has a multiplicity of oxirane groups; more preferably, the thermosettable compound is a novolac resin, a di-, tri- or tetraglycidyl ether or a di-, or tri- or tetraglycidyl ester.

Examples of suitable thermosettable compounds include the diglycidyl ether of bisphenol A, the diglycidyl ether of bisphenol F, 1,4-butanediol diglycidyl ether, 1,6-hexanediol diglycidyl ether, the diglycidyl ester of phthalic acid, 1,4-cyclohexanedmethanol diglycidyl ether, 1,3-cyclohexanedmethanol diglycidyl ether, the diglycidyl ester of hexahydrophthalic acid, and novolac resins, and combinations thereof. A commercially available thermosettable compound is D.E.R. 331 Liquid Epoxy Resin (available from Olin Corporation).

Aqueous dispersions of the acrylic polymer particles (i.e., latexes) can be achieved through free radical emulsion or suspension addition polymerization or by dispersion of a pre-formed polymer under shear into an aqueous medium. Examples of suitable latexes include acrylic and styrene-acrylic based latexes.

The acrylic polymer particles may further contain anti-agglomerating functional groups, which refer to hydrophilic groups that are sufficiently unreactive with the oxirane groups (and ester groups, if present) such that the latex particles are heat-age stable at 60° C. for 10 days. The term “heat-age stable at 60° C. for 10 days” is used herein to mean that the particle size of a latex subjected to heat-aging at 60° C. for 10 days stability does not increase by more than 30% beyond the particle size before such heat-age studies.

Anti-agglomerating functional groups can be incorporated into the polymer particles using monomers containing anti-agglomerating functional groups (anti-agglomerating monomers), although it would also be possible to incorporate such groups by grafting. The anti-agglomerating groups are believed to be effective because they are hydrophilic as well as non-reactive with oxirane groups under heat-age conditions. The general class of such groups includes amide groups, acetoacetoxy groups, and strong protic acids, which are pH adjusted to form their conjugate bases.

Specific examples of anti-agglomerating monomers include acrylamide, phosphoethyl methacrylate, sodium styrene sulfonate, acetoacetoxyethyl methacrylate, and acrylamido-methyl-propane sulfonate. When present, the concentration of anti-agglomerating functional groups in the polymer is preferably sufficient to stabilize the thermoplastic polymer under heat-age conditions, preferably from 0.5, and more preferably from 1, to preferably 10, and more preferably to 5 weight percent, based on the weight of the polymer.

Monomers suitable for the preparation of acrylic latexes include acrylates and methacrylates such as methyl acrylate, ethyl acrylate, butyl acrylate, 2-ethylhexyl acrylate, methyl methacrylate, ethyl methacrylate, butyl methacrylate, and 2-ethylhexyl methacrylate, and combinations thereof. Furthermore, the acrylic latexes may also include structural units of other monomers such as styrene and acrylonitrile. As used herein, the term “structural units” refers to the remnant of a named monomer after polymerization.

Structural units of one or more acid monomers may also be included, most notably acrylic acid, methacrylic acid, and itaconic acid. Monomers capable of imparting co-curable functionality such as glycidyl acrylates and methacrylates may also be included.

It may be advantageous to include chain transfer agents in the latex preparation. Examples of chain transfer agents include, but are not limited to, dodecylmercaptan, butylmercaptopropionate, methylmercaptopropionate, mercaptopropionic acid, etc.

In certain embodiments it may be advantageous to incorporate into the polymer copolymerized multi-ethylenically unsaturated monomer groups. Multi-ethylenically unsaturated monomers include, for example, allyl (meth)acrylate, diallyl phthalate, 1,4-butylene glycol di(meth)acrylate, 1,2-ethylene glycol di(meth)acrylate, 1,6-hexanediol di(meth)acrylate, and divinyl benzene. It may be especially advantageous to incorporate such monomer groups non-uniformly into the polymer to form multiphase polymer particles to create a core-shell, hemispherical, or occluded morphology.

The aqueous dispersion of acrylic polymer particles imbibed with an epoxy compound (i.e., the imbibed latex) is advantageously prepared separately from the thermosettable compound using conventional emulsion polymerization techniques, then combined with the thermosettable compound, which can be neat or in the form of an aqueous emulsion, preferably as an aqueous emulsion, more preferably as a micronized aqueous emulsion. When the thermosettable compound is added as an aqueous emulsion, the emulsion is stabilized with a stabilizing amount of a surfactant, preferably at a concentration in the range of about 0.5 to about 10% by weight. Nonionic surfactants are preferred, including APEO free, non-ionic wetting agents such as polyalkylene oxide block copolymers, polyoxyethylene glycol alkyl ethers, glucoside alkyl ethers, fatty acid esters, glycerol alkyl esters, sorbitan alkyl esters, and polyoxyethylene glycol alkylphenol ethers, including commercially available wetting agents such as TRITON™ X-405 Octylphenol Ethoxylate (A trademark of The Dow Chemical Company or its Affiliates). When the thermosettable compound is combined with the latex as a neat compound, imbibing is facilitated by agitation at or above room temperature.

High solids content imbibed latexes, that is, latexes with solids content of at least 40 weight percent and particularly in the range of 45 to 60 weight percent, based on the total weight of the latex, can be used in the present invention.

The imbibed latex composition is useful as one part (i.e., binder component) of a two-component formulation, the second component being a curing (i.e., crosslinking) component that is added prior to use that causes the thermosettable compound to cure or set. Accordingly, the binder component of the present invention is substantially free of a curing agent; that is, there is insufficient concentration of a compound that promotes oxirane ring opening to destabilize the thermosettable compound. Preferably, the imbibed latex composition contains not more than 0.05 weight percent, more preferably not more than 0.005 weight percent, and most preferably 0 weight percent of a curing agent based on the total weight of the imbibed latex composition.

Preferably the imbibed latex in the binder component is cured with a water compatible external curing agent comprising the curing component. Preferably, the imbibed latex is cured with a carboxylic acid-based acrylic. Examples of carboxylic acid-based acrylics include, for example, acrylic polymer emulsions comprising but not limited to structural units derived from carboxylic acids such as, for example, methacrylic acid, itaconic acid, and acrylic acid, and acrylic monomers including methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, methyl methacrylate, butyl methacrylate, hexyl methacrylate, isobutyl methacrylate, isopropyl methacrylate, 2-hydroxyethyl acrylate, acrylamide, acrylonitrile, methacrylonitrile isobornyl acrylate, n-propyl methacrylate, sec-butyl methacrylate, cyclohexyl methacrylate, t-butylaminoethyl methacrylate, stearyl methacrylate, glycidyl methacrylate, dicyclopentenyl methacrylate, and phenyl methacrylate, and optionally structural units derived from styrene. For example, the acrylic polymer emulsion may comprise a styrene-acrylic polymer emulsion.

Preferably, the acrylic polymer emulsions comprises 35 to 70 weight percent, and more preferably from 40 to 65 weight percent, of acrylic solids based on the total weight of the acrylic polymer emulsions. Preferably, the acrylic particles have an average weight particle size diameter in the range from 60 to 450 nm, acid level in the range of from 0.1 to 15 weight percent of acid monomers based on the weight of the acrylic monomer, a weight average molecular weight in the range of from 50,000 to 5,000,000 g/mole, and a glass transition temperature (Tg) in the range of from 7 to 100° C. as measured by differential scanning calorimetry (DSC). The acrylic polymer dispersion preferably has a pH in the range of from 6 to 10.

The amount of curing agent used generally varies from about 1:1 to 2.5:1 epoxy to carboxylic acid stoichiometry based on moles of epoxide groups to moles of carboxylic acid. Preferably, the curing component is present in the coating composition in an amount such that the stoichiometry between epoxy groups to acid groups ranges from 1:1 to 1.5:1 based on moles of epoxide groups to moles of carboxylic acid in the coating composition. More preferably, the curing component is present in the coating composition in an amount such that the stoichiometry between epoxy groups to acid groups ranges from 1:2 to 1.4:1 based on moles of epoxide groups to moles of carboxylic acid in the coating composition.

The two-component waterborne coating composition further comprises a coalescent package. The coalescent package comprises at least one coalescent. As used herein, the term “coalescent” refers to non-volatile or slow-evaporating solvents that fuse polymer particles into a continuous film under ambient conditions.

Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. Commercially available coalescents include, for example, OPTIFILM™ 400 and TEXANOL™ Coalescent, both available from The Eastman Chemical Company.

Preferably, at least one coalescent in the coalescent package is present in an amount ranging from 2 to 10 wt %, preferably 3 to 9.5 wt %, and more preferably 4 to 9 wt %, based on a total weight of solids in the binder component and curing component of the coating composition, where the total solids amount does not include any additional components (e.g., pigment present in the coating composition).

The coating composition has a minimum film formation temperatures (MFFT) from 0° C. to 25° C., preferably from 5° C. to 15° C. The MFFT is the lowest temperature at which the polymer particles on the aqueous dispersion will mutually coalesce and form a continuous film when the volatile component (e.g., water) evaporates. The MFFT can be measured in accordance with GB/T 9267-2008.

The coating composition according to the present invention may further include one or more of the following additives: solvents; fillers; pigments, such as titanium dioxide, mica, calcium carbonate, silica, zinc oxide, milled glass, aluminum trihydrate, talc, antimony trioxide, fly ash, and clay; polymer encapsulated pigments, such as polymer-encapsulated or partially encapsulated titanium dioxide, zinc oxide, or lithopone; polymers or polymer emulsions adsorbing or bonding to the surface of pigments such as titanium dioxide; hollow pigments, including pigments having one or more voids; dispersants, such as aminoalcohols and polycarboxylates; surfactants; defoamers; preservatives, such as biocides, mildewcides, fungicides, algaecides, and combinations thereof; flow agents; leveling agents; and additional neutralizing agents, such as hydroxides, amines, ammonia, and carbonates.

The volatile organic compound (VOC) content of the coating composition may range from 0.2 to 1 lb/gal, preferably from 0.25 to 0.85 lb/gal, and more preferably from 0.25 to 0.75 lb/gal.

The pigment volume concentration (PVC) of the f coating composition may be calculated by the following equation:

$$PVC = \frac{( V olume of Pigment )}{( V olume of Pigment + V olume of Dry Latex )}$$

For example, the PVC of the coating composition may range from 7.5 to 12.5%.

A second aspect of the present invention relates to a method of preparing a coating. The method comprises a coating composition, as described above.

A coating layer is formed by applying the coating composition to a substrate. The coating layer is then cured at a temperature greater than room temperature for at least 10 minutes. Preferably, the curing temperature is at least 50° C., more preferably at least 60° C., and the curing time is preferably at least 15 minutes. The coating layer may be flashed at room temperature prior to curing to allow volatile components to evaporate.

Preferably the substrate is a metal substrate. The metal substrate may be either bare metal (e.g., the coating is a direct-to-metal coating) or a primed metal substrate (e.g., a metal substrate primed with a zinc-rich primer).

In a preferred embodiment, the coating layer is formed on a substrate that comprises a cured basecoat layer such that the coating layer forms a topcoat over the basecoat. Preferably, the basecoat layer is formed from a two-component waterborne basecoat coating composition comprising a basecoat binder component and a basecoat curing component. The basecoat binder component may be the same or different from the binder component of the topcoat coating composition. Similarly, the basecoat curing component may be the same or different from the curing component of the topcoat coating composition. Preferably, the basecoat binder component is the same as the binder component of the topcoat coating composition and the basecoat curing component is the same as the curing component of the topcoat coating composition, i.e., the basecoat coating composition and the topcoat coating composition are based on a single-chemistry resin system.

The basecoat coating composition further comprises a basecoat coalescent package comprising at least one coalescent, which may be the same or different than the at least one coalescent of the topcoat coating composition. The at least one coalescent in the basecoat coalescent package may be present in an amount ranging from 10 to 30 wt %, preferably from 15 to 25 wt %, based on a total weight of solids in the basecoat binder component and the basecoat curing component of the basecoat coating composition, where the total solids amount does not include any additional components (e.g., pigment present in the basecoat coating composition).

The basecoat coating composition preferable has a MFFT of less than 5° C., preferably from −10° C. to 5° C.

The basecoat curing component may be present in the basecoat coating composition in an amount from 1.75:1 to 2.5:1 epoxy to carboxylic acid stoichiometry based on moles of epoxide groups to moles of carboxylic acid in the basecoat coating composition, preferably from 2.0:1 to 2.5:1.

The basecoat coating composition may have a VOC content ranging from 0.75 to 1.25 lb/gal, and a PVC ranging from 15 to 20%.

A third aspect of the present invention relates to an article comprising a coating layer formed by the coating composition.

Preferably, the coating layer has a Persoz hardness of at least 50 sec, more preferably at least 60 sec, and even more preferably at least 70 sec, as measured according to the method described below.

Examples—The following examples are for illustrative purposes only and are not intended to limit the scope of the invention. The following materials are used in the examples:

AEH-1 is an AEH dispersion having a solids content of 53.9%, an epoxy equivalent weight of 312 g/eq based on weight solids and a pH of 7.

AEH-2 is an AEH dispersion having a solids content of 52.2%, an epoxy equivalent weight of 468 g/eq based on weight solids and a pH of 7.

SAP is a carboxylic-acid functional styrene-acrylic polymer dispersion with a solids content of 49.5% and an acid equivalent weight of 2457 g/eq on polymer solids and is used as a curing agent.

DOWANOL™ DPnB is a dipropylene glycol mono n-butyl ether available from The Dow Chemical Company and is used as a coalescent.

OPTIFILM 400 is a coalescent available from Eastman Chemical Company.

OROTAN™ 681 is a polymethacrylic acid with hydrophobic comonomers available from The Dow Chemical Company and is used as a dispersant.

ACRYSOL™ RM-12W is a nonionic urethane rheology modifier available from The Dow Chemical Company.

TEGO Airex 902W is a polyether siloxane copolymer emulsion available from Evonik Corporation and is used as a defoamer.

Ti-PURE R-706 is a titanium dioxide pigment available from The Chemours Company.

TAMOL™ 681 is a hydrophobic copolymer dispersant available from The Dow Chemical Company.

TRITON™ HW-1000 is a nonionic surfactant available from The Dow Chemical Company.

ANCAMINE K-54 is a tris-(dimethylaminomethyl) phenol curing agent available from Evonik Corporation.

XIAMETER™ OFS-6020 is an aminoethylaminopropyl trimethoxysilane coupling agent available from The Dow Chemical Company.

### Preparation of Coating Compositions

The pigment grind for Base 1, Base 2, and the Inventive Coating Composition was prepared according to Table 1 below. The following ingredients were added to 1 L stainless steel container and mixed at low shear (1000 rpm) on a dispersator with a 2″ cowles blade until uniform (~5 min): 299.56 g deionized water, 11.68 g Ammonia (28%), 7.49 g Foamex 1488, 48.13 g Tamol 681, and 9.99 g Triton HW1000. After approximately 5 minutes, 1123.15 g of TiPure R706 was added slowly under shear. Mixing speed was increased gradually to achieve a good vortex. After all of the TiO2 was added, the dispersator was stopped so that the blade, shaft, and sides of container could be scraped with a metal spatula. The dispersator was then turned on and the speed was increased to ~2000 rpm. Mixing was complete after approximately 15 min when the Hegman gauge read 7-8 units. The pigment grind was then ready to be added to formulation in Table 2 as listed below.

TABLE 1

| Component | Weight (grams) |
|---|---|
| Deionized Water | 499.27 |
| Ammonia (28%) | 19.47 |
| TEGO Foamex 1488 | 12.48 |
| TAMOL ™ 681 | 80.22 |
| TRITON ™ HW1000 | 16.64 |
| Ti-Pure R-706 TiO2 | 1871.91 |
| Total | 2500 |

Two basecoat coating compositions, Base 1 and Base 2, and a coating according to the present invention were prepared using two different acrylic epoxy hybrids, AEH-1 and AEH-2, respectively. Part B side mixtures were prepared in a plastic container of appropriate size for contents (8 oz. to 32 oz.) using a metal paddle blade (1″ diameter) on a lab mixer set to an appropriate speed (500-1000 rpm) to maintain a good vortex. The first ingredient was added on a lab balance, whereas, additional ingredients were added while mixing to enable good incorporation. After last ingredient was added, the mixture was allowed to mix for an additional 15 minutes at ~1100 rpm. Part B sides were allowed to equilibrate overnight before mixing together with a tongue depressor and making a coating.

TABLE 2

| | | | Inventive |
|---|---|---|---|
| | | | Coating |
| | Base 1 | Base 2 | Composition |
| Component | Wt (grams) | Wt (grams) | Wt (grams) |
| Part A | | | |
| AEH-1 (53.9%) | 6.35 | — | — |
| AEH-2 (52.2%) | — | 9.07 | 6.76 |
| Part B | | | |
| SAP (49.5%) | 23.57 | 22.87 | 30.25 |
| ANCAMINE K-54 | 0.13 | — | 0.16 |
| TEGO Airex 902W | 1.69 | 1.77 | 1.70 |
| Pigment Grind (shown in | 17.02 | 17.76 | 10.74 |
| Table 1) | | | |
| DOWANOL ™ DPnB | 2.18 | 2.31 | 0.74 |
| OPTIFILM 400 | 0.79 | 0.84 | 0.37 |
| Sodium Nitrite 15% | 0.49 | 0.52 | 0.53 |
| TRITON ™ HW-100 | — | — | 0.05 |
| XIAMETER ™ OFS-6020 | 0.22 | 0.22 | 0.10 |
| Deionized Water | 3.80 | 3.55 | 5.18 |
| ACRYSOL ™ RM-12W | 0.11 | 0.17 | 0.18 |
| Total Part B | 50 | 50 | 50 |
| Total Mixed | 56.35 | 59.07 | 56.76 |

The properties for Base 1, Base 2, and the Inventive Coating Composition are shown in Table 3.

TABLE 3

| | | | Inventive |
|---|---|---|---|
| | | | Coating |
| | Base 1 | Base 2 | Composition |
| Properties | Value | Value | Value |
| Molar Ratio (epoxy/acid) | 2.3/1 | 2.3/1 | 1.3/1 |
| % PVC | 17.0 | 17.0 | 10.0 |
| VOC (lb/gal) | 0.91 | 0.91 | 0.33 |
| % Wt Solids | 52.8 | 52.9 | 49.2 |
| % Vol Solids | 40.9 | 40.9 | 40.8 |
| % Coalescent | 19.7 | 19.6 | 6.0 |

### 2-Layer Coated Metal Samples

Samples were prepared by coating an iron phosphate (BONDERITE 1000) cold rolled steel substrates with a two-layer coating. In Example 1, a first coat of Base 1 was applied, followed by a coating of the Inventive Coating Composition. Example 2 was prepared by coating the substrate with a first layer of Base 2 and a second layer of the Inventive Coating Composition. Comparative Example 1 was prepared by coating the substrate with a first layer of Base 2 and a second layer of Base 1. To prepare Example 3, two layers of the Inventive Coating Composition were applied. In each of the 2-layer coating samples, the first layer was applied and flashed off at room temperature for 30 minutes and then cured at 80° C. for 20 minutes. The sample was then allowed to cool for 1 to 2 hours until it reached room temperature before the second layer was applied. The second coating was flashed off at room temperature for 30 minutes and then cured at 80° C. for 20 minutes. After curing, the coated metal samples were kept at room temperature for 7 days before testing.

A Persoz pendulum was used to test the hardness of each of the coated metal samples following ASTM-D4366. The results for the Persoz hardness testing is shown below in Table 4, which also shows that each sample had a relatively similar thickness and gloss, as tested by micro-TRI-gloss machine (BYK Company). The hardness of Examples 1, 2 and 3 was significantly improved compared to the 2-layer coating of Comparative Example 1, which lacked a layer comprising the Inventive Coating Composition.

TABLE 4

| | Dry Film | | |
|---|---|---|---|
| | Thickness | Persoz | 60° |
| Sample | (μm) | (sec) | Gloss |
| Example 1 | 56 | 86 | 74 |
| Example 2 | 60 | 74 | 84 |
| Comparative | 58 | 46 | 81 |
| Example 1 | | | |
| Example 3 | 58 | 119 | 83 |

### Single-Layer Coated Metal Samples

Single-layer coated metal samples were prepared on iron phosphate (BONDERITE 1000) coated cold rolled steel substrates. Comparative Example 2 was prepared by coating Base 2 on the metal substrate. Comparative Example 3 was prepared by blending 1:1 by Base 2 and the Inventive Coating Composition and formed the coating as a single layer on the substrate. Example 4 was prepared by coating the metal substrate with a single layer of the Inventive Coating Composition. Each sample was prepared by coating a single layer on the substrate and flashing off for 30 minutes at room temperature and curing at 80° C. for 20 minutes, followed by 7 days at room temperature before testing.

The results of the hardness testing is shown below in Table 5.

TABLE 5

| | Dry Film | | |
|---|---|---|---|
| | Thickness | Persoz | 60° |
| Sample | (μm) | (sec) | Gloss |
| Comparative | 74 | 31 | 78 |
| Example 2 | | | |
| Comparative | 78 | 43 | 84 |
| Example 3 | | | |
| Example 4 | 79 | 87 | 87 |

Although Comparative Example 3 exhibited slightly better hardness than Comparative Example 2, the hardness of Example 3 was significantly lower than the 2-layer coated metal sample of Example 2. Example 4 had a significantly higher hardness compared to Comparative Examples 2 and 3.

A direct comparison of Example 2 and Comparative Example 3 clearly demonstrates that using different formulations in 2 separate layers with at least partial curing between each layer can significantly improve the hardness of the resulting coating.

1. A two-component coating composition comprising a binder component and a curing component, wherein the binder component comprises an aqueous dispersion of acrylic polymer particles imbibed with an epoxy compound, wherein the two-component waterborne coating composition comprises a coalescent package comprising at least one coalescent and has a minimum film formation temperature (MFFT) from 0° C. to 25° C.

2. The coating composition of claim 1, wherein the curing component is selected from carboxylic acid-based acrylic curing agents.

3. The coating composition of claim 1, wherein the curing component is present in an amount such that the molar ratio of epoxy groups to carboxylic acid groups ranges from 1:1 to 2.5:1 in the coating composition.

4. The coating composition of claim 1, wherein the coalescent package is present in an amount in the range of from 2 to 10 wt % based on a total weight of solids in the binder component and the curing component of the two-component coating composition.

5. The coating composition of claim 4, wherein the coalescent package is present in an amount in the range of from 3 to 9.5 wt % based on a total weight of solids in the binder component and the curing component of the coating composition.

6. The coating composition of claim 1, wherein the coating composition has a MFFT from 0° C. to 15° C.

7. The coating composition of claim 1, wherein the coating composition has a VOC content ranging from 0.2 to 1 lb/gal.

8. The coating composition of claim 1, wherein the coating composition has a PVC of 7.5 to 12.5%.

9. A method comprising the steps of:
(i) applying the coating composition of claim 1 to a substrate to form a coating layer; and
(ii) curing the coating layer to form a coating on the substrate at a temperature greater than room temperature for at least 10 minutes.

10. The method of claim 9, wherein the substrate comprises a metal substrate.

11. The method of claim 9, wherein the substrate comprises at least one basecoat layer formed thereon prior to the step of applying the coating composition to the substrate.

12. The method of claim 11, wherein the basecoat layer is formed from a two-component basecoat coating composition comprising a basecoat binder component and a basecoat curing component, wherein the basecoat binder component and the basecoat curing component are independently the same or different from the binder component and curing component of the coating composition, wherein the basecoat binder component comprises an aqueous dispersion of acrylic polymer particles imbibed with an epoxy compound, wherein the two-component basecoat coating composition comprises a basecoat coalescent package comprising at least one coalescent and has a MFFT less than 5° C.

13. The method of claim 12, wherein the basecoat binder component and the basecoat curing component are the same as the binder component and curing component of the coating composition

14. The method of any claim 9, wherein in step (ii) coating layer is cured at a temperature of at least 50° C. for at least 15 minutes.

15. (canceled)
